(19) United States
(12) Patent Application Publication
(10) Pub. No.: US 2005/0140781 A1
(43) Pub. Date: Jun. 30, 2005

(54) Video coding method and apparatus thereof

(76) Inventors: Ming-Chieh Chi, Feng-Shan City (TW); Mei-Juan Chen, Hualien City (TW)

Correspondence Address: J.C. Patents, Inc., Suite 250, 4 Venture, Irving, CA, 92618, US

(21) Appl. No.: 10/748,474

(22) Filed: Dec. 29, 2003

(51) Int. Cl. H04N 7/14

(52) U.S. Cl. 348/14.13

(57) ABSTRACT

A region-of-interest (ROI) video-coding method and apparatus based on fuzzy logic control for a video encoder is provided. Providing an image having a plurality of region-of-interest regions and a plurality of non-region-of-interest regions, the first step is to separate the region-of-interest regions and the non-region-of-interest regions from the image. Then by sending an input from the region-of-interest regions to a fuzzy logic control, in which the fuzzy logic control performs fuzzy manipulations that enhances the quality of the region-of-interest regions, and thereof the overall quality of an output image. The method and apparatus are particularly useful in videophone and videoconferencing.

### BACKGROUND OF THE INVENTION

1. Field of the Invention

The present invention is generally related to a technique for enhancing the quality of an image. More particularly, the present invention relates to a region-of-interest (ROI) video-coding algorithm based on fuzzy control method for a video encoder, for example, a H.263+ type video encoder.

2. Description of the Related Art

The demand for applications of the digital video communication, such as videoconferencing and videophone, has increased considerably. However, the transmission rates over network are restricted, hence very low bit-rate video coding for such applications is an important technology to reduce the data rate of picture sequence without losing much of its subjective quality. Most implementations of these standards give equal importance to each block. While different blocks within the same picture may be coded with different modes, no one block is more important than the other is. This model is not appropriate for any region-of-interest (ROI) application on video sequence. In H.263+ standard, the distortion weight parameter and the signal variance at macro-block (MB) layer are adjusted to control the qualities at different regions. The blocks correspond to some focus areas are more important than the blocks in the background or unwanted areas. Allocating more bandwidth towards the quality of areas that user focuses on, while sacrificing background or unwanted areas quality is a better coding strategy for video sequences like video conferencing. Except the ROI has more high quality, it may discard some background information to improve the encoding speed. Like maximum bit transfer (MBT), the background is always encoded with the coarsest quantization level as in. A region-based blurring algorithm to reduce bit-rate in very low bit-rate video coding is adopted. Another method improves quality at ROI significantly by three fixed factors to each ROI MBs and non-ROI MBs in order to enhance the quality of ROI regions, and reduce the bits for coding the background. The present invention can improve ROI quality adaptively according to fuzzy logic rate control and it is suitable for real time videoconferencing.

Fuzzy logic was first proposed by L. A. Zadeh working at Berkeley in 1965 and it is modeled after the natural way people arrive at solutions in three points. The first point: applying different solution methodologies to the same problem. The second point: applying more than one of our rules to the same problem at the same time. The third point: accepting a certain amount of imprecision, which is very important at helping us arrive at workable solutions. Obviously, normal rate control algorithms in different standard test models, such as TMN5, TMN8, and etc., are conformed to these three points. In each test models, there are particular mathematical solutions to determine the quantization parameters for each MB and a few inaccuracies are acceptable to estimate the bit rate for the next MB. It seems that a fuzzy logic control could play a suitable role in solving the rate control in video coding.

FIG. 1a shows a block diagram of a conventional feedback control system 100. This controller makes its decisions about what to do based on either a mathematical model of the process or a fixed set of mathematical relationship.

FIG. 1b shows a block diagram of a fuzzy logic control system 150. The fuzzy logic controller 150 uses as its guide a set of response rules established by the knowledgeable operators or system engineers. Referring to FIG. 1b, a quantizer 152 takes the data from a sensor 157 and converts the data into a format, which can be used by a fuzzy logic controller 153. The fuzzy logic controller 153 then performs calculations to determine a fuzzy situation for that particular data.

To summarize, as the information highway has already begun, and with a limited transmission rate, a method for enhancing an image is needed. Currently, a region-of-interest (ROI) method that can improve an image's quality is already existed. However, the present solutions for the ROI methods still have barriers in the performance. Therefore and for the foregoing reasons, there is a desperate need for a method or algorithm that is able to obtain a high quality video image.

### SUMMARY OF THE INVENTION

The present invention is directed to a method and apparatus that satisfies the need to enhance the quality of an image in applications such as videophone and videoconferencing. To achieve these and other advantages and in accordance with the purpose of the invention, as embodied and broadly described herein, a new method and apparatus based on region-of-interest (ROI) and fuzzy logic control are provided.

First, the method separates a plurality of region-of-interest regions from a plurality of non-region-of-interest regions of an image. Then, an input from the region-of-interest regions is sent to a fuzzy logic controller, wherein the fuzzy logic controller is used for enhancing the quality of the region-of-interest regions and the overall quality of an output image.

In one preferred embodiment of the present invention, the input from the region-of-interest regions is calculated from a first control input and a second control input from the region-of-interest regions. Wherein, the first control input and the second control input comprise a first variance from a present (i)th macro-block and a variance difference, respectively. The variance difference is calculated by subtracting a second variance of a previous (i−1)th macro-block from the first variance and then dividing by the first variance. The (i)th macro-block and the (i−1)th macro-block represent a sequence of macro-block within one of the region-of-interest regions and the (i−1)th macro-block is a previous macro-block of the (i)th macro-block.

In another preferred embodiment of the present invention, the fuzzy logic control includes a methodology to convert the control inputs to fuzzy predicates

In another preferred embodiment of the present invention, the fuzzy logic control includes a controlling function to calculate a linguistic membership function for determining a fuzzy situation of the main control input. The controlling function uses center of area (COA) method to determine the linguistic membership function.

In another embodiment of the present invention, the fuzzy logic control includes a plurality of lookup tables for making a decisional level and producing a weighted factor to emphasize the qualities of one of the region-of-interest regions.

In yet another embodiment of the present invention, the lookup tables comprise a plurality of scaled lookup tables for providing a priority-like quality for one of the region-of-interest regions. Wherein, the scaled lookup tables are formed by using a one-fixed and one-various membership function.

To summarize, a fuzzy controlled ROI video coding is provided. The fuzzy controlled ROI video coding has the capability of adjusting the output quality of an image adaptively. The approach can enhance the quality of ROI easily, maintain the constant bit-rate to avoid buffer overflow, and achieve good quality easily with fewer bit-rates than previous works. The multiple ROI video coding can also enhance each ROI's output quality significantly without complex computation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1a illustrates a conventional feedback control algorithm.

FIG. 1b illustrates a conventional fuzzy logic control algorithm.

FIG. 2 illustrates one embodiment of the present invention showing a block diagram of region-of-interest video coding by fuzzy logic control algorithm.

FIG. 3 illustrates one version of a variance i subsets of the fuzzy logic control device as shown in FIG. 2.

FIG. 4 illustrates one version of a variance change Δi subsets of the fuzzy logic control device as shown in FIG. 2.

FIG. 5 illustrates one version of a fuzzy output lookup table of the fuzzy logic control device as shown in FIG. 2.

FIG. 6 illustrates one version of a one-fixed and one-various membership function.

FIG. 7 illustrates one comparison of different methods for Carphone sequence at 64 kbits/sec for 100 frames.

FIG. 8 illustrates one comparison of different methods for Claire sequence at 32 kbits/sec for 150 frames.

FIG. 9 illustrates one comparison of different methods for Foreman sequence at 64 kbits/sec for 150 frames.

FIG. 10 illustrates one comparison of multiple region-of-interest for News sequence at 64 kbits/sec for 150 frames.

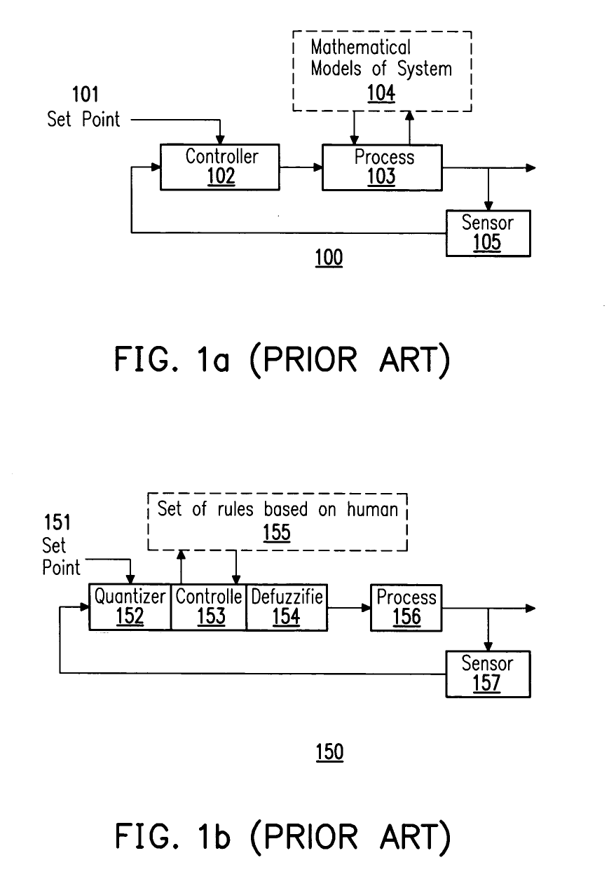

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

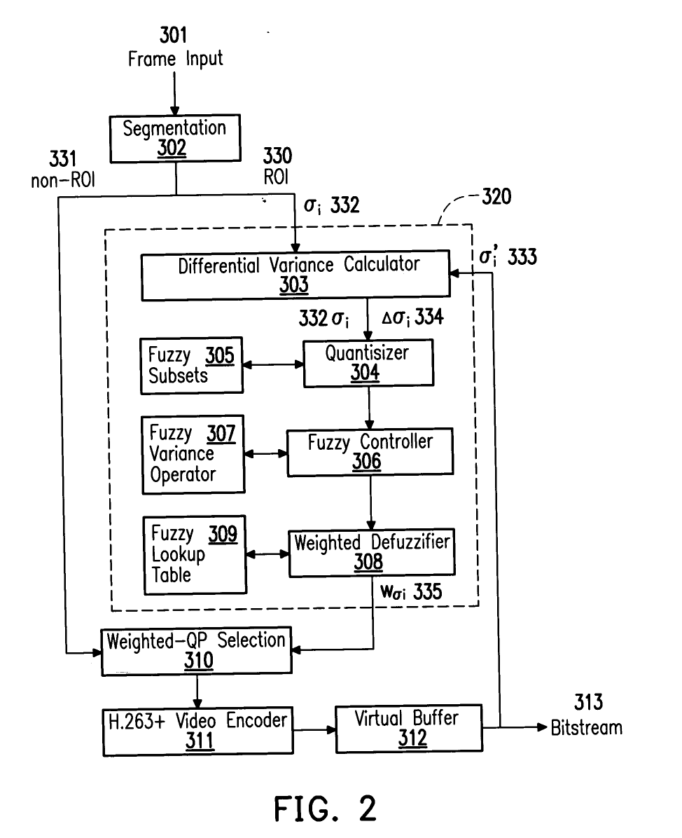

To begin with, a region-of-interest video coding by fuzzy control, consisted of two main components: (1) a region-of-interest, and (2) a fuzzy control. Referring to FIG. 2, a region-of-interest includes segmentation 302. Whereas a fuzzy logic controller 320 includes: a differential variance calculator 303; a quantizer 304; fuzzy subsets 305; a fuzzy controller 306; a fuzzy variance operator 307; a weighted defuzzifier 308; and a fuzzy lookup table 309. In addition, a H.263+ video encoder and a virtual buffer are also included for an overall coding system.

Also referring to FIG. 2, a fuzzy logic controller 320 enhances the quality of region-of-interest according to a variance σᵢ 332 and a variance difference Δσᵢ.334. After a frame 301 is input, the segmentation 302, such as face detection and motion detection, are used to separate the frame 301 into region-of-interest (ROI) regions 330 and non-ROI regions 331. The macro-blocks in non-ROI region 331 are sent directly to a QP selection 310 in rate control without adjusting any parameters. The variance difference Δσᵢ 334 in the i-th macro-block of one of the ROI regions 330 is calculated from σᵢ 332 and σᵢ′ 333, where σᵢ′ 332 and σᵢ′ 333 are variances of the current and the previous i-th MB, respectively. The variance difference Δσᵢ 334 and the current MB variance σᵢ 332 are the two inputs to apply the fuzzy logic method and ω_{94 i} 335 is a fuzzy output to be the weighted factor of input.

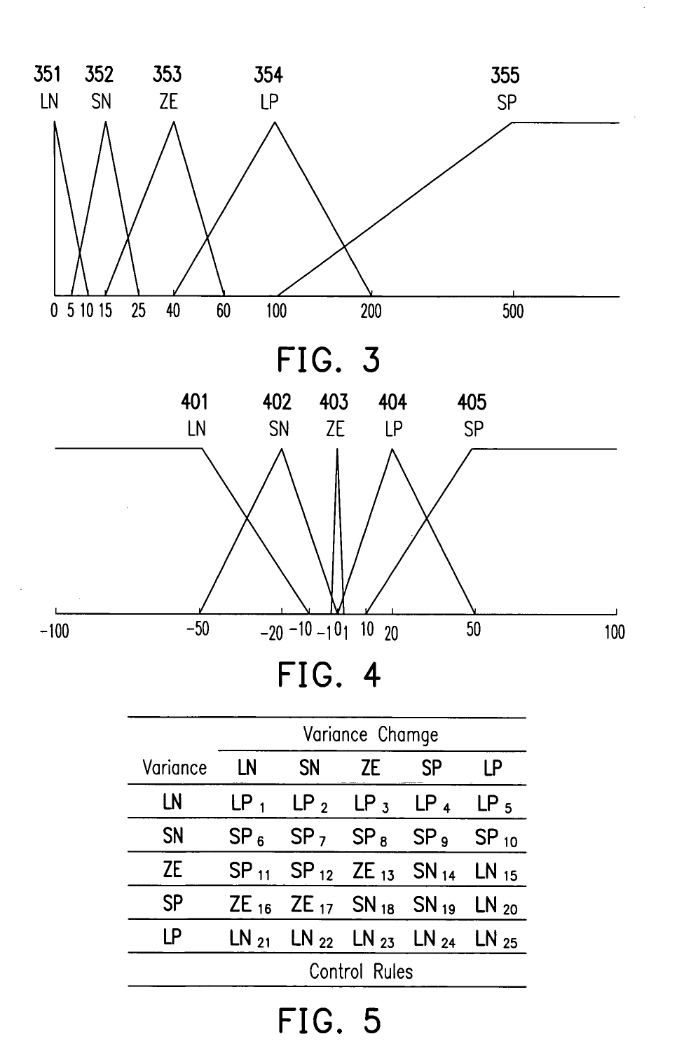

FIG. 3 and FIG. 4 are the graphical representations of σᵢ 332 and Δσᵢ 334, respectively. Referring to FIG. 3 and FIG. 4, the notations, which are qualitative statements of linguistic sets, LN 351 and 401, SN 352 and 402, ZE 353 and 403, LP 354 and 404, and SP 355 and 405 are “Large Positive”, “Small Positive”, “Zero”, “Small Negative” and “Large Negative”, respectively. The notations of FIG. 3 are the same as that of FIG. 4 except all the σᵢ 332 are positive and the most variances σᵢ 334 of each MB center on ZE 303 in the statistics. FIG. 4 shows the subsets of the variance difference Δσᵢ 334, which is defined as Δσᵢ=(σᵢ-σᵢ′) /σᵢ

Referring to FIG. 4, most Δσᵢ 334 are concentrated in [−10, +10] in the statistics. Next, the quantizer 304 takes the σᵢ 332 and Δσᵢ 334 into the fuzzy subsets 305 and convert their degrees into fuzzy predicates such as LN 351, SN 352, ZE 353, LP 354, and SP 355. The fuzzy controller 306 then calculates the linguistic membership function by the quantized σᵢ 332 and Δσᵢ 334, and utilizes the center of area (COA) method to determine the fuzzy situation. After the calculations, each σᵢ/Δσᵢ pair has a corresponding main control input value. The decision table is stored in memory in the form of a fuzzy lookup table 309 as shown in FIG. 5. The weighted defuzzifier 308 takes the two situations of σᵢ/Δσᵢ into account according to the fuzzy lookup table 309 and ω_{σi} 335, the weighted factor, is outputted to emphasize the ROI 330 macro-blocks' qualities.

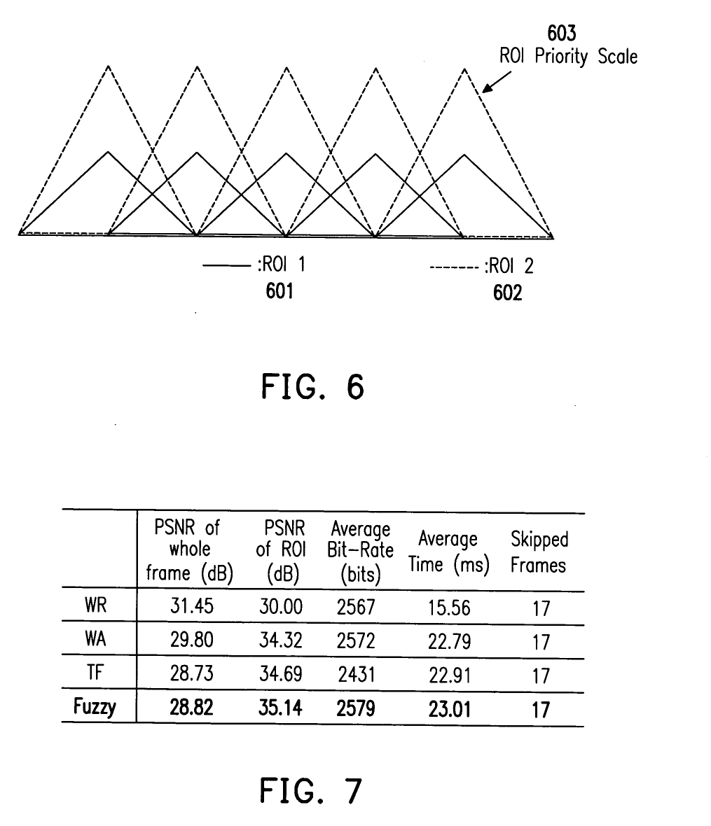

In one embodiment of the present invention, a set of different output fuzzy tables is scaled by the original output fuzzy in order to have different priorities to different ROI regions 330. FIG. 6 describes a one-fixed and one-various membership function, which is used to utilize and distinguish the different ROI 330 from each ROI priority. The weighted factors are calculated by the fuzzy rule and given to each MB in the H.263+ video encoder 311.

As an experimentation for one embodiment of the present invention shows the embodiment of the present invention has a better performance than other existing methodologies. In the experimental results, three sequences: Carphone; Claire; and Foreman are tested. In order to define the ROI regions in a frame, a face detection is used to select ROI automatically. Four different methods in the test sequences are compared. The four different methods are: coding a frame without ROI (WR), coding the ROI regions by multiplying a weighted factor (WA) α, coding the ROI regions by three factors (TF), and the presnet invention (Fuzzy). The four different methods are all set to the similar average bit-rate. In an implementation, QP is set to 5 and 3 for I-frame and P-frame at target bit-rate 64 kbits/sec, and 15 and 13 for I-frame and P-frame at target bit-rate 32 kbits/sec, respectively. In WA, the weighted factor is set to be 450. In TF, the three factors are set to be 450, 2, and 10, respectively. In order to compare the other two methods in similar weights, ZE₁₃ is set to be 450 and LP₁˜LN₂₅ are set to be in 350˜550.

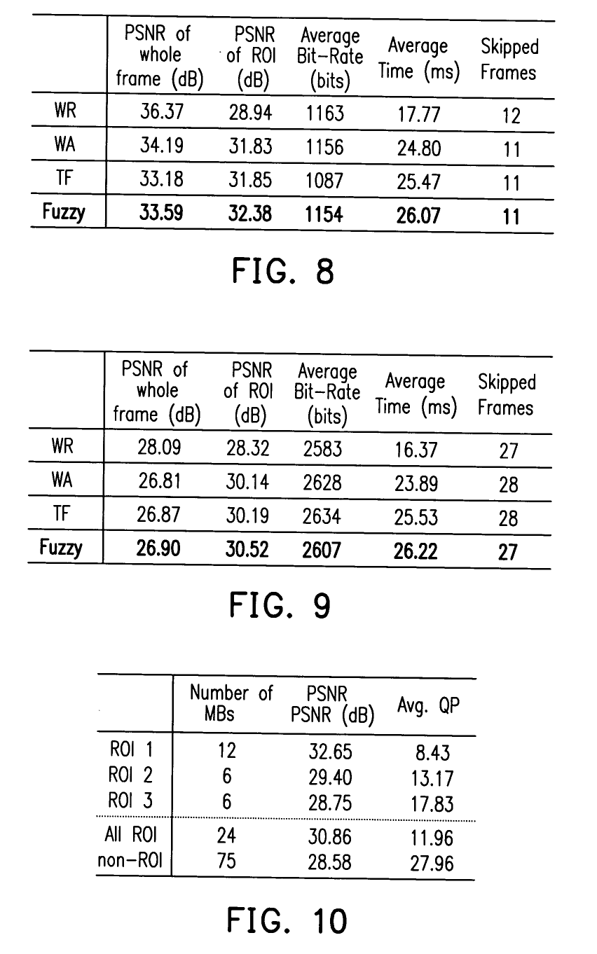

As illustrated from FIG. 7 to FIG. 10, the embodiment of the present invention has a better PSNR of ROI in the similar bit-rates compared to the other methods. Since both of WA and TF enhance the ROI quality by fixed factors, the two methods cannot adjust the weighted factor when the complexity of each MB changes rapidly. To summarize, the embodiment of the present invention obtains better quality in ROI regions and less skipping frames even with lower bit-rate.

The present invention is suitable in any image processing. It is particular useful for real-time video coding. Accordingly, the present invention can enhance the quality of ROI easily and maintain the constant bit-rate to avoid buffer overflow. It can achieve good quality easily with fewer bit-rates than previous works. The multiple ROI video coding can also enhance each ROI's quality significantly without complexity computation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A video coding method, suitable for use in videophone and videoconferencing, comprising:
separating a plurality of region-of-interest regions from a plurality of non-region-of-interest regions of an image; and
sending an input from the region-of-interest regions to a fuzzy logic control, wherein the fuzzy logic control is used for enhancing the quality of the region-of-interest regions and the overall quality of an output image.

2. The video coding method of claim 1, wherein the input from the region-of-interest regions is calculated from a first control input and a second control input from the region-of-interest regions.

3. The video coding method of claim 2, wherein the first control input and the second control input comprise a first variance from a present (i)th macro-block and a variance difference respectively, the variance difference is calculated by subtracting a second variance of a previous (i−1)th macro-block from the first variance and then dividing by the first variance, the (i)th macro-block and the (i−1)th macro-block represent a sequence of macro-block within one of the region-of-interest regions and the (i−1)th macro-block is a previous macro-block of the (i)th macro-block.

4. The video coding method of claim 1, wherein the fuzzy logic control includes a methodology to convert the input from the region-of-interest regions to fuzzy predicates.

5. The video coding method of claim 1, wherein the fuzzy logic control includes a controlling function to calculate a linguistic membership function for determining a fuzzy situation.

6. The video coding method of claim 5, wherein the controlling function comprises a center of area (COA) method to determine the linguistic membership function.

7. The video coding method of claim 1, wherein the fuzzy logic control includes a plurality of lookup tables for making a decisional level and producing a weighted factor to emphasize the quality of one of the region-of-interest regions.

8. The video coding method of claim 7, wherein the lookup tables comprise a plurality of scaled lookup tables for providing a priority-like quality for one of the region-of-interest regions.

9. The video coding method of claim 8, wherein the scaled lookup tables are formed by using an one-fixed and one-various membership function.

10. The video coding method of claim 1, wherein the fuzzy logic control, is further comprising:
converting an input from the region-of-interest regions to fuzzy predicates;
calculating a linguistic membership function using a controlling function for each of the fuzzy predicates for determining a fuzzy situation; and
forming a plurality of lookup tables from the fuzzy situation for making a decisional level and producing a weighted factor to emphasize the quality of one of the region-of-interest regions.

11. The video coding method of claim 10, wherein the input from the region-of-interest regions is calculated from a first control input and a second control input from the region-of-interest regions.

12. The video coding method of claim 11, wherein the first control input and the second control input comprise a first variance from a present (i)th macro-block and a variance difference respectively, the variance difference is calculated by subtracting a second variance of a previous (i−1)th macro-block from the first variance and then dividing by the first variance, the (i)th macro-block and the (i−1)th macro-block represent a sequence of macro-block within one of the region-of-interest regions and the (i−1)th macro-block is a previous macro-block of the (i)th macro-block.

13. The video coding method of claim 10, wherein the controlling function uses center of area (COA) method to determine the linguistic membership function.

14. The video coding method of claim 10, wherein the lookup tables comprise a plurality of scaled lookup tables for providing a priority-like quality for one of the region-of-interest regions.

15. The video coding method of claim 14, wherein the scaled lookup tables are formed by using an one-fixed and one-various membership function.

16. A video coding apparatus, suitable for use in videophone and videoconferencing, comprising:
an encoder having an input terminal and an output terminal, wherein the input terminal of an encoder is electrically coupled to an input frame;
a segmentation device having an input terminal, a first output terminal and a second output terminal, wherein the input terminal of the segmentation device is electrically coupled to the input frame; and
a fuzzy logic control device having an input terminal and an output terminal, wherein the input terminal of the fuzzy logic control device is electrically coupled to the first output terminal of the segmentation device and the output terminal of the fuzzy logic control device is electrically coupled to the input terminal of the encoder.

17. The video coding apparatus of claim 16, wherein the fuzzy logic control device, is further comprising:
a quantizer having an input terminal and an output terminal, wherein the input terminal of the quantizer is electrically coupled to the first output terminal of the segmentation device for converting a signal from the first output terminal of the segmentation device to a fuzzy predicate;
a first controller having an input terminal and an output terminal, wherein the input terminal of the first controller is electrically coupled to the output terminal of the quantizer for converting the fuzzy predicate to a fuzzy situation; and
a second controller having an input terminal and an output terminal, wherein the input terminal and the output terminal of the second controller is electrically coupled to the output terminal of the first controller and the input terminal of the encoder respectively for converting the fuzzy situation to an output of the fuzzy logic control device.

18. The video coding apparatus of claim 17, is further comprising a differential device having an input terminal and an output terminal, wherein the input terminal and the output terminal of the differential device is electrically coupled to the first output terminal of the segmentation device and the input terminal of the quantizer, respectively.

19. The video coding apparatus of claim 18, wherein the input terminal of the encoder is electrically coupled to the second output terminal of the segmentation device.

20. The video coding apparatus of claim 19, further comprising a buffer having an input terminal and an output terminal, wherein the input terminal and the output terminal of the buffer is electrically coupled to the output terminal of the encoder and the first output terminal of the segmentation device respectively.
